(19) United States
(12) Patent Application Publication
(10) Pub. No.: US 2006/0211808 A1
(43) Pub. Date: Sep. 21, 2006

(54) Adhesive composition

(76) Inventors: Pia Frei, Rickenbach (CH); Andreas Dobmann, Oberkirch (CH)

Correspondence Address: SHOEMAKER AND MATTARE, LTD, 10 POST OFFICE ROAD - SUITE 110, SILVER SPRING, MD, 20910, US

(21) Appl. No.: 10/563,149

(22) PCT Filed: May 8, 2004
(86) PCT No.: PCT/EP04/04930

§ 371 Date: Feb. 9, 2006

(30) Foreign Application Priority Data
Jul. 4, 2003 (EP) 03015190.6

(51) Int. Cl. C09B 67/00

(52) U.S. Cl. 524/502; 604/365

(57) ABSTRACT

The invention relates to an adhesive composition containing (a) an elastomer block copolymer having a diblock portion greater than 40%, preferably greater than 55%, more preferably greater than 70%, (b) a sulphonated, especially branched copolyester and (c) optionally, additional additives, such as tackifiers and/or softeners and/or stabilisers. The inventive adhesive compositions have advantages, particularly, based on high wet-peel strength.

### ADHESIVE COMPOSITION

The invention relates to an adhesive composition, to the use of such an adhesive composition, to a method of joining substrates using such an adhesive composition, and to a device having at least one region which has been prepared with such an adhesive composition for joining to a substrate. The invention relates in particular to pressure-sensitive hot-melt adhesives and to their use, particularly for bonding substrates to skin.

Known from the document U.S. Pat. No. 5,028,485 is a pressure-sensitive adhesive composition suitable for skin contact. It comprises a polymer, a copolymer or a mixture of polymer and/or copolymer; additionally, customary additives may be provided. Essential to the invention is the addition of relatively high concentrations of 1-20% by weight of one or more silane compounds, which improves the wet peel strength. However, the use of a reactive silane compound is associated with considerable drawbacks:
possible classification of the silane compound as a hazardous substance may result in a hazard labeling obligation;
the adhesive gives off a pronounced odor which is perceived as unpleasant;
there is an allergenic potential for skin irritation.

The use of sulfonated polyesters in hot-melt adhesives is known—from the document U.S. Pat No. 6,428,900, for example. According to that document, however, adhesive compositions containing 10% to 90% of a branched, sulfonated copolyester, and bonds produced using them, dissolve in the presence of water.

Furthermore, from the document EP 761 795 B1, it is known to mix further elastomeric polymers, such as styrene-containing block copolymers, for example, additionally, if desired, into sulfonated copolyesters. These adhesive compositions are preferably not pressure-sensitive; moreover, for many applications, including in particular those in the medical sector, as for example for self-adhesive drapes for bonding to skin, the wet peel strength is inadequate, owing to the inherent water-solubility of the sulfonated copolyesters, especially branched sulfonated copolyesters.

U.S. Pat. No. 6,025,071 describes a detachable (“removable grade”) hot-melt adhesive comprising a styrene-isoprene-styrene block copolymer having a diblock fraction of more than 50%. It is assumed that the high diblock fraction contributes to improved adhesion to the base substrate. For adhesive compositions of this kind it has emerged, however, that for many applications, particularly for bonding to the skin, the wet peel strength is inadequate.

It is therefore an object of the invention to avoid the drawbacks of the known art and so in particular to provide an adhesive composition which has improved wet peel strength, particularly to skin, and which is also unproblematic in its handling and compatibility. It is a further object of the invention to provide an adhesive composition which can be applied inexpensively and without special precautions.

In accordance with the invention these objects are achieved by means of an adhesive composition and the use of such a composition, and a method using such an adhesive composition, and also a device, having the features of the independent claims.

An adhesive composition according to the invention comprises an elastomeric block copolymer having a diblock fraction of more than 40%, preferably of more than 55%, more preferably of more than 70%, and a sulfonated copolyester, in particular a branched copolyester. The adhesive composition may further comprise, if desired, further additives such as tackifiers and/or plasticizers and/or stabilizers.

By an elastomeric block copolymer is meant, here and below, in particular, polymers of the general formula A-B or A-B-A, A denoting a thermoplastic block and B a block having rubber-elastic and/or elastomeric properties, especially rubberlike properties. The thermoplastic A block is preferably a polymer of one or more alkenylaromatics, especially styrene (with which particularly advantageous properties have been achievable) and its homologs, e.g., α-methylstyrene; 4-substituted styrenes, e.g., 4-(4-phenyl-n-butyl)styrene, and in particular 4-alkylstyrenes, e.g., 4-methylstyrene, 4-n-propylstyrene, and 4-cyclohexylstyrene; 5-substituted styrenes, especially 5-alkylstyrenes, e.g., 5-tert-butylstyrene; 3,5-disubstituted styrenes, especially 3,5-dialkylstyrenes, e.g., 3,5-diethylstyrene and 3,5-di-n-butylstyrene; 2,4-disubstituted styrenes, e.g., 2-ethyl-4-benzylstyrene, and in particular 2,4-dialkylstyrenes, e.g., 2,4-dimethylstyrene; and vinyltoluene. The rubber-elastic and/or elastomeric, especially rubberlike, B block is preferably a polymer of a conjugated, branched or linear, lower-aliphatic diene, in particular having 4, 5 or 6 carbons, such as butadiene, 1,3-pentadiene, isoprene, 2,3-dimethylbutadiene, 1,3-hexadiene, and/or the fully or partly hydrogenated derivatives thereof. Particularly advantageous properties have been achievable with isoprene.

The preparation of block copolymers of this kind is known per se. Where styrene is used as A block and isoprene as B block, the terms S-I and S-I-S block copolymers are used as well. One adhesive composition of the invention uses block copolymers of this kind having a diblock fraction of more than 40%, preferably of more than 55%, more preferably of more than 70%. Block copolymers of this kind are available commercially, examples being Kraton™ D 1119 (Kraton Polymers, 66% diblock fraction) and Quintac™ 3520 (Zeon Chemicals, 78% diblock fraction). The diblock fraction, here and below, is the fraction, as a proportion of the entirety of the block copolymers, of molecules containing one block A and one block B as defined above, these blocks being joined to one another, if desired, by constituent units which are not part of the blocks.

By a sulfonated copolyester is meant, here and below, not only linear but also branched sulfonated copolyesters. Particular preference is given to using copolyesters which have a difunctional sulfo monomer unit with at least one −SO₃H or −SO₃M functionality (M=metallic counterion) on a preferably aromatic nucleus. Preferred aromatic nuclei are benzene, naphthalene, anthracenes, biphenyl, oxybiphenyl, sulfonylbiphenyl, and methylenebiphenyl. Particularly preferred difunctional sulfo monomer units are 5-sodium sulfonate isophthalic acid, 5-sodium sulfonate isophthalate, 5-lithium sulfonate isophthalic acid, and bis(2-hydroxyethyl)-5-sodium sulfonate isophthalate. Within the backbone of the sulfonated copolyesters, especially branched copolyesters, the stated sulfo monomer units are arranged preferably in random distribution; this can be achieved, for example, by copolymerization into the polymer backbone. The preparation of sulfonated copolyesters of this kind, especially branched copolyesters, is known per se. Those available commercially are, in particular, branched, sulfonated copolyesters containing the sulfo monomer unit 5-sodium sulfonate isophthalic acid, e.g., Eastman™ AQ 1950.

Surprisingly it has now been found that through the combination of elastomeric block copolymers with a high diblock fraction and sulfonated copolyesters, especially branched copolyesters, it is possible to obtain adhesive compositions which have an improved wet peel strength. The dry and wet peel strengths were determined by means of a method corresponding substantially to the technique disclosed in the document U.S. Pat. No. 5,028,485, column 4, lines 20-38.

In one particularly preferred embodiment of the invention the adhesive composition contains 10%-40% by weight of at least one copolymer having a diblock fraction of more than 40%, preferably of more than 55%, more preferably of more than 70%, 5%-30% by weight of a sulfonated copolyester, in particular a branched copolyester, 20%-60% by weight of a tackifier, 10%-30% by weight of a plasticizer, and preferably at least one auxiliary, in particular a stabilizer.

By tackifiers are meant, here and below, resins in particular. In the context of the invention it is possible with preference to use natural and modified resins, examples being gum resins, wood resins, colophony resins, oil resins, distilled resins, hydrogenated resins, and dimerized and polymerized resins. Additionally use may also be made of esters, especially glycerol or pentaerythritol esters of natural or modified resins, particularly glycerol esters of wood resins, glycerol esters of hydrogenated resins or the like; furthermore, it is also possible to employ aliphatic, aromatic or mixed aliphatic/aromatic hydrocarbon resins and phenolically modified terpene resins or their hydrogenated derivatives. For particular applications it is of course also possible to use mixtures of the stated tackifiers. A tackifier for use with particular preference in the context of the invention is Foral™ 85-E from Eastman™, an ester of a hydrogenated resin.

By plasticizers are meant, here and below, substances which can be added to the adhesive composition in order to enhance its processing and elastic properties, especially flexibility and stretchability; an additional action as a plasticizer is possible. Plasticizers commonly for use in the context of the invention are, in particular, polyesters, epoxides, phosphoric acid derivatives, phthalic acid derivatives, isophthalic acid derivatives, biphenyl derivatives, maleic acid derivatives, glycolates, citric acid derivatives, benzoic acid derivatives, adipic acid derivatives, castor oil, mineral oils, and glyceryl trihydroxyoleate, and also liquid, hydroxylated fatty acids and/or conjugated fatty acids, isostearic acid for example. A plasticizer for use with preference in the context of the invention is available commercially from BASF under the name VISTANEX™ PAR 950, a medium-molecular mass polybutene.

By auxiliaries are meant, here and below, substances including, in particular, inorganic diluents or fillers (examples being calcium carbonate, zinc oxide, titanium oxide, talc, carbon black, clays or the like), UV absorbers, heat stabilizers, release agents, anti-stick agents, and antioxidants. Preferred antioxidants for use in the adhesive compositions of the invention are available under the name IRGANOX™ from Ciba SC, especially Irganox 1010.

According to one particularly preferred embodiment of the invention the adhesive composition comprises as a copolymer component with a diblock fraction of more than 40%, preferably of more than 55%, more preferably of more than 70%, a styrene block copolymer, preferably a styrene-isoprene block copolymer. With block copolymers of this kind it has been possible to obtain particularly advantageous properties in respect in particular of the improved wet peel strength.

In one further embodiment of the invention an adhesive bond which can be produced by the adhesive composition has a 180° wet peel strength of more than 8 N/m, preferably of more than 16 N/m, more preferably of 24 N/m or more. The wet peel strengths were determined using a 23 μ polyester film backing material by means of a method corresponding essentially to the technique disclosed in the document U.S. Pat. No. 5,028,485, column 4, lines 20-38.

The adhesive composition of the invention is used with particular advantage to join natural or synthetic, especially textile, sheetlike structures to one another and/or to a second substrate, in particular the skin. The enhanced wet peel strength makes it possible in particular to ensure a durable bond in a moist environment.

The invention also relates, furthermore, to methods of joining substrates using an adhesive composition of the invention, and in particular of joining a substrate to the skin. The adhesive compositions of the invention can be employed with particular advantage in all methods of joining substrates where one of the key factors is an increased wet peel strength.

The invention relates, further, to products having at least one region which is prepared for joining to a substrate, this region being provided at least partly with a coating comprising an adhesive composition of the invention. This may relate, inter alia and in particular, to a natural or synthetic, especially textile, sheetlike structure and/or an adhesive tape. One preferred area of application in particular is that of medical adhesive tapes or adhesive sections on, for example, surgical drapes, but in particular also patches, ECG electrodes or the like. The adhesive compositions of the invention fulfill outstandingly the wet peel strength and skin compatibility requirements that are high particularly in these areas of application.

The invention is elucidated in more detail below, with reference to exemplary embodiments, without the subject matter of the invention being restricted to these exemplary embodiments.

TABLE 1
Adhesive compositions (A*, B*, C*: comparative
experiments; D, E: inventive adhesive compositions)
and their dry and wet peel strengths

| | % | | | | | |
|---|---|---|---|---|---|---|
| | Diblock | A* | B* | C* | D | E |
| Kraton D 1111 | 15 | 4.6 | 4.1 | — | — | — |
| Kraton D 1112 | 38 | 14.8 | 13.3 | — | — | — |
| Europrene | 25 | 5.7 | 5.1 | — | — | — |
| SOL T 190 | | | | | | |
| Kraton D- | 66 | — | — | — | 22.6 | — |
| 1119P | | | | | | |
| Quintac 3520 | 78 | — | — | 25.1 | — | 22.6 |
| AQ 1950 | | — | 10.0 | — | 10.0 | 10.0 |
| Foral 85-E | | 51.2 | 46.1 | 51.2 | 46.0 | 46.0 |
| Vistanex | | 22.7 | 20.4 | 22.7 | 20.4 | 20.4 |
| PAR 950 | | | | | | |
| Irganox 1010 | | 1.0 | 1.0 | 1.0 | 1.0 | 1.0 |
| Viscosity in | | 4200 | 1700 | 4000 | 2400 | 4300 |
| mPa*s | | | | | | |
| (160° C.) | | | | | | |
| 180° peel | | 140 | 260 | 308 | 272 | 276 |
| strength | | | | | | |
| (N/m), dry | | | | | | |
| 180° peel | | 2.0 | 6.4 | 16.0 | 8.8 | 24.0 |
| strength | | | | | | |
| (N/m), wet | | | | | | |

Table 1 shows the composition of selected examples of inventive adhesive compositions (D and E) and also comparative experiments, which are marked by * (A*, B* and C*).

Ingredients of the Adhesive Compositions

Ingredients used in the adhesive compositions were the following, commercially available products: Kraton™ D-1111 (diblock fraction 15%), Kraton™ D-1112 (diblock fraction 38%), and Kraton™ D-1119P, all from Kraton Polymers; Europrene SOL T 190 (diblock fraction of 25%) from Polimeri Europa; Quintac™ 3520 (78% diblock fraction) from Zeon Chemicals; Foral™ 85-E from Eastman; Vistanex™ PAR 950 from BASF; and Irganox™ 1010 from Ciba SC.

Comparative Experiments

Comparative experiment A* shows an adhesive composition comprising a mixture of styrene-isoprene block copolymers with a low diblock fraction (15%, 38%, and 25%). Not only the dry peel strength but also the wet peel strength are inadequate for many areas of application. Even by adding a sulfonated copolyester in comparative experiment B* it is already possible to achieve an improvement in dry and wet peel strength by a factor of around 2 or 3. The use of a styrene-isoprene block copolymer having a high diblock fraction of 78% in comparative experiment C*, instead of the mixture of the block copolymers with a low diblock fraction, is able again to improve the wet peel strength in particular by a factor of approximately 2.5 as compared with comparative experiment B*.

Inventive Adhesive Compositions

The adhesive compositions according to exemplary embodiments D and E combine the high diblock fraction of the block copolymer with the admixture of a sulfonated copolyester. Adhesive compositions D and E differ only in the differing diblock content of the block copolymer. From adhesive composition E in particular it becomes clear that with an inventive adhesive composition it is possible to achieve wet peel strengths which were not achievable with any of comparative experiments A*, B*, and C*. A comparison in particular between comparative experiment C* (no sulfonated polyester) and the adhesive composition E reveals a positive effect on the wet peel strength achievable.

Apart from this, the inventive adhesive compositions enjoy essentially the same advantageous processing and compatibility properties, in particular with respect to the skin, as are already known for adhesive compositions similar to comparative experiments A*, B*, and C*.

Determination of Dry and Wet Peel Strengths

The dry and wet peel strengths were determined by means of a method corresponding essentially to the technique disclosed in the document U.S. Pat. No. 5,028,485, column 4, lines 20-38.

This is a force measurement using a tensile testing machine. The parameter determined is the force required to detach an adhesive material, adhered under defined conditions to a certain test material, from that test material again, at a defined peel angle and at a defined speed. The tensile testing machine used was an Instron™ 5565, the backing material a nonwoven Omnidrape from Paul Hartmann. The sample under test is likewise applied to a surgical drape of this kind (test strip 25 mm wide and 150 mm long; coat weight 50 g/m²) and bonded to the backing material. Bonding is accomplished by over-rolling once with a 0.5 kg press roller. The adhered test strips are tested dry after 30 minutes; for determining the wet peel strength, the bonded specimens are wetted after 30 minutes with 2 ml of deionized water, and tested after a further 5 minutes. The measurement is made with a peel angle of 180° and a peel speed of 300 mm/minute. The values reported correspond to the average from 4 independent measurements.

1-10. (canceled)

11. An adhesive composition containing
(a) an elastomeric block copolymer having a diblock fraction of more than 40%;
(b) a sulfonated copolyester;
(c) if desired, further auxiliary additives.

12. The adhesive composition of claim 11, containing
(a) 10%-40% by weight of at least one elastomeric block copolymer having a diblock fraction of more than 40%;
(b) 5%-30% by weight of a sulfonated copolyester;
(c) 20%-60% by weight of a tackifier;
(d) 10%-30% by weight of a plasticizer;
(e) preferably at least one auxiliary additive.

13. The adhesive composition of claim 12, wherein the at least one auxiliary additive is a stabilizer.

14. The adhesive composition of claim 11 comprising as ingredient (a) a styrene block copolymer.

15. The adhesive composition of claim 14, wherein the styrene block copolymer is a styrene-isoprene block copolymer.

16. The adhesive composition of claim 11, characterized in that the diblock fraction of ingredient (a) is not more than 90%.

17. The adhesive composition of claim 11, characterized in that a bond producible using the adhesive composition has a 180° wet peel strength of more than 8 N/m.

18. The use of an adhesive composition of claim 11 for joining natural or synthetic, sheetlike structures to one another or to a second substrate.

19. The use according to claim 18, wherein said second substrate is skin.

20. A method of joining substrates, characterized in that the join is effected by means of an adhesive composition of claim 11.

21. The method of claim 20, characterized in that a join between a substrate and the skin is effected.

22. A product having a region which is prepared for joining to a substrate, this region being provided at least partly with a coating comprising an adhesive composition of claim 11.

23. The product of claim 22, characterized in that it is a natural or synthetic, sheetlike structure or an adhesive tape.

24. The adhesive composition of claim 11, wherein the sulfonated copolyester is branched.
